(19) United States
(12) Patent Application Publication
(10) Pub. No.: US 2017/0011399 A1
(43) Pub. Date: Jan. 12, 2017

(54) RULE-BASED LOCKING AND UNLOCKING OF PAYMENT ACCOUNTS

(71) Applicant: HRB Innovations, Inc., Las Vegas, NV (US)

(72) Inventors: Greg Steinlicht, Shawnee, KS (US); Daniel D. Martin, Kansas City, MO (US)

(21) Appl. No.: 14/795,230

(22) Filed: Jul. 9, 2015

(51) Int. Cl. G06Q 20/40; G06Q 20/32; G06Q 20/28

(52) U.S. Cl. CPC G06Q 20/405; G06Q 20/28; G06Q 20/3226

(57) ABSTRACT

System, method, and interface for rule-based locking and unlocking of payment accounts. Embodiments of the invention allow a user to define rules for circumstances when their payment vehicle will not, or should not, be used. In such circumstances, the payment account may be locked and rendered unusable, thereby causing any fraudulent or otherwise undesirable transactions which may be attempted to be rejected. The payment vehicle may subsequently be automatically or manually unlocked for normal use. In order to accomplish this, the user may be provided with an interface to define rules for when and how their accounts should be locked and unlocked.

### RELATED APPLICATION

This non-provisional patent application shares certain subject matter with concurrently-filed U.S. patent application Ser. No. ______ filed ______ and entitled LOCATION-BASED LOCKING AND UNLOCKING OF PAYMENT ACCOUNTS, and with previously filed U.S. patent application Ser. No. 14/697,101 and entitled PAYMENT VEHICLE FOR BUDGETING; Ser. No. 14/697,043 entitled UNIFIED PAYMENT VEHICLE; and Ser. No. 14/697,233 entitled PAYMENT VEHICLE WITH PERSONALIZED REWARDS PROGRAM, all filed Apr. 27, 2015. The identified earlier-filed patent applications are hereby incorporated by reference in their entirety into the present application.

### BACKGROUND

1. Field

Embodiments of the invention generally relate to payment systems, and more particularly to a payment vehicle which can automatically be activated and deactivated (i.e., locked and unlocked) based on rules specified by the user.

2. Related Art

Traditionally, payment vehicles (such as, for example, credit cards, debit card, and prepaid cards) are shipped to the user in a deactivated state. Once the user receives and activates the card, typically by calling the issuing bank, it can be used to make purchases. In the event that the card is stolen, the user can report the theft in order to have the card deactivated and a replacement issued. However, such activations and deactivations are rare events in the lifecycle of the payment vehicle.

At the same time, payment fraud is on the rise. While financial institutions that issue cards can combat fraud by examining transaction patterns and rejecting transactions deemed to be suspicious, users are in the best position to know when an authorized transaction is being made. Accordingly, there is a need for a fraud-reduction system whereby a user can specify circumstances when they will not be making transactions so that fraudulent transactions can be automatically rejected.

A related issue is budgeting. Traditionally, consumers who adopt a household budget find that the most difficult part of the budgeting process is compliance. While a budget may be planned out with the best of intentions, a consumer may not have the willpower to stick to the planned budget when faced with temptation. Accordingly, there is a need for a budget-compliance system whereby the user can specify circumstances when transactions, even by authorized users of a payment vehicle and even when funds are available, should be declined.

### SUMMARY

Embodiments of the invention address the above problem by allowing the user to define rules for circumstances when transactions using their payment vehicle should be allowed of disallowed. When transactions should be disallowed, the payment vehicle can be temporarily deactivated, thereby causing any (presumably fraudulent or undesired) transactions to be rejected based on the time of the transaction, the merchant with whom the transaction is being conducted, the amount of the transaction, or other factors. In particular, in a first embodiment, the invention includes a system for rules-based activation and deactivation of a payment vehicle, comprising a data store storing user-defined rules for activating and deactivating the payment vehicle, an interface allowing a user to modify the user-defined rules, an activation engine, operable to activate and deactivate the payment vehicle based at least in part on the user-defined rules, the payment vehicle associated with the user and usable by the user to initiate a transaction, and a transaction approval engine, operable to approve or reject the transaction based at least in part on whether the payment vehicle is active.

In a second embodiment, the invention includes a method of authorizing a transaction for an account associated with a user, comprising the steps of receiving, from the user, a rule for determining when the account should be locked, applying the rule to lock the account, receiving information relating to a transaction for the account, rejecting the transaction because the account is locked, and sending, to the user, a notification that the transaction was rejected because the account was locked.

In a third embodiment, the invention includes one or more computer-readable media storing instructions which, when executed by a processor, generate a user interface for allowing a user to define rules for locking and unlocking an account, comprising an interface element for allowing a user to specify a time when the account should be locked or unlocked, an interface element for allowing a user to specify a transaction that should cause the account to be locked or unlocked, an interface element for allowing the user to lock the account, and an interface element for allowing the user to unlock the account.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an exemplary hardware platform for certain embodiments of the invention;

FIG. 2 depicts a system suitable for use with certain embodiments of the invention;

FIG. 3 depicts an exemplary user interface for configuring rules is depicted in accordance with certain embodiments of the invention; and

FIG. 4 depicts a method in accordance with embodiments of the invention.

The drawing figures do not limit the invention to the specific embodiments disclosed and described herein. The drawings are not necessarily to scale, emphasis instead being placed upon clearly illustrating the principles of the invention.

### DETAILED DESCRIPTION

At a high level, embodiments of the invention allow a user to define rules for automatically disabling and re-enabling their payment account. Users may wish to selectively lock their account for a number of reasons. One such reason is to prevent fraudulent use of the account. For example, a business credit card account might only be used Monday through Friday; the user of such an account could specify that the account is to be automatically deactivated at 5 pm on Friday and then reactivated at 9 am on Monday. If the account were compromised (either by having a card physically stolen or by having the account number stolen) any transactions attempted over the weekend will automatically be rejected. Similarly, an account used for automatic payment of fixed expenses could be kept deactivated on all days other than those with scheduled payments, while an account used to manage petty cash could be automatically locked in response to an attempted purchase over $50.

Another reason a user might lock their account is to enforce a budget or prevent uncontrolled spending. For example, a user who habitually makes large, unwanted, late-night purchases online might lock their account at midnight and unlock it at 8 am. Alternatively, the user might lock their account for several hours after an evening transaction is processed at a restaurant or bar. As another example of locking an account for budgeting, a user might lock an account used for discretionary expenses after $500 of purchases have been made in a particular billing cycle, even if funds left in the account would otherwise permit additional purchases to be made that billing cycle.

In order to accomplish this, the user is provided with an interface to define rules for when and how their accounts should be locked and unlocked. To make such a system easier to use, the system may have the ability to suggest rules for the user, or trained customer-service representatives may be made available to assist the user through the process. Such rules, once defined by the user, can be stored with other account authorization information. Once the rules are defined and stored, they can automatically lock and unlock the account either on a schedule defined by the user or in response to account activity. This locked or unlocked status can be checked as a part of the conventional transaction authorization process.

The subject matter of embodiments of the invention is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be obvious to one skilled in the art, and are intended to be captured within the scope of the claimed invention. Terms should not be interpreted as implying any particular ordering of various steps described unless the order of individual steps is explicitly described.

The following detailed description of embodiments of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments, but is not necessarily included. Thus, the technology can include a variety of combinations and/or integrations of the embodiments described herein.

### I. Operational Environment for Embodiments of the Invention

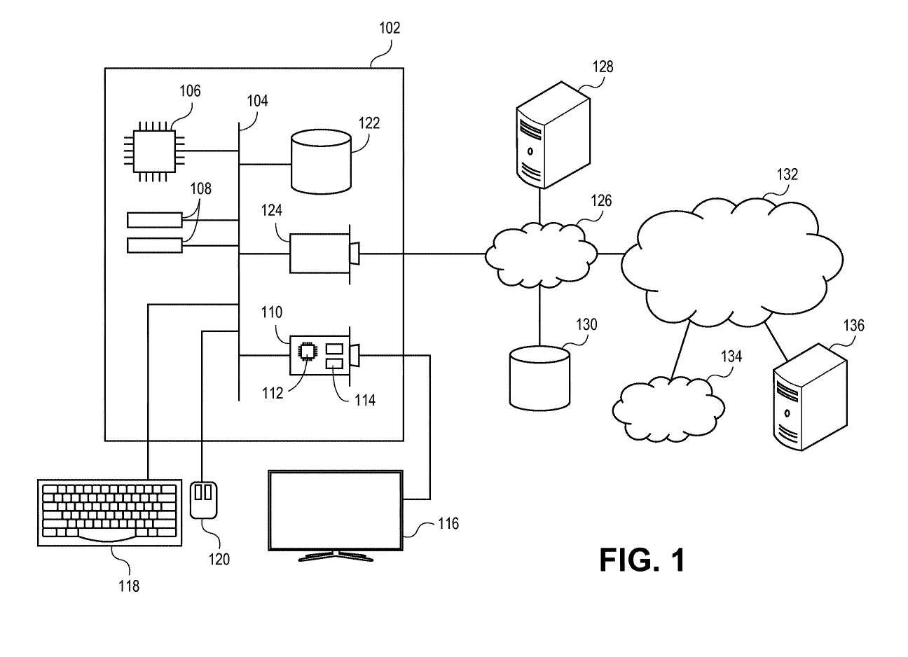

Turning first to FIG. 1, an exemplary hardware platform for certain embodiments of the invention is depicted. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is central processing unit (CPU) 106. Also attached to system bus 104 are one or more random-access memory (RAM) modules. Also attached to system bus 104 is graphics card 110. In some embodiments, graphics card 104 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments no display is present, while in others it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media, and may be internally installed in computer 102 or externally and removeably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 124 is also attached to system bus 104 and allows computer 102 to communicate over a network such as network 126. NIC 124 can be any form of network interface known in the art, such as Ethernet, ATM, fiber, Bluetooth, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

### II. Operation of Embodiments of the Invention

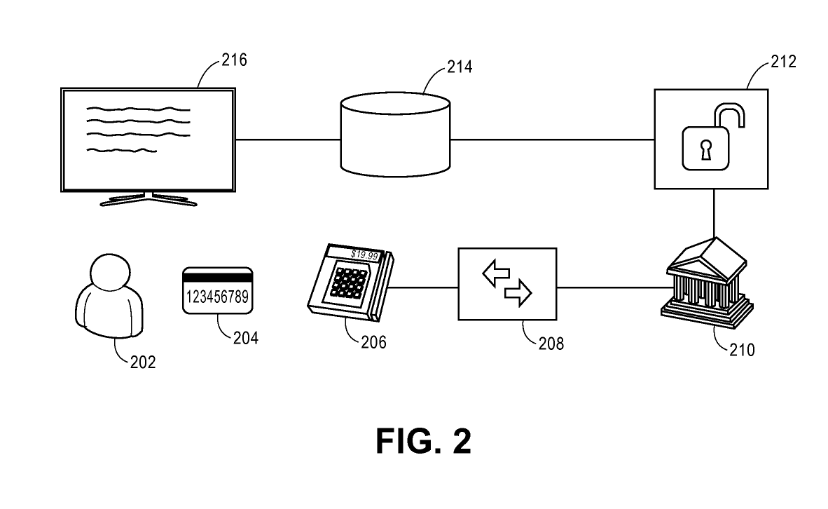

Turning now to FIG. 2, a system suitable for use with certain embodiments of the invention is depicted. Initially, user 202 is issued payment vehicle 204. In some embodiments, user 202 is an individual with an individual account. In other embodiments, user 202 is an individual with access to a joint account. In still other embodiments, user 202 is a representative with access to an organizational account. For brevity, the term “user” will be used interchangeably herein to refer to an owner of a financial account linked to payment vehicle 204, a party using payment vehicle 204 to conduct a transaction, or an individual acting on behalf of the account owner to configure rules as described below.

Payment vehicle 204 can also take on a variety of forms. In some embodiments, payment vehicle 204 is a credit card. In other embodiments, payment vehicle 204 is a debit card. In still other embodiments, payment vehicle 204 is a pre-paid card or a gift card. Similarly, payment vehicle 204 can be embodied in a variety of ways. For example, in one embodiment, payment vehicle 204 is a magnetic-stripe card. In another embodiment, payment vehicle 204 is a chip-and-PIN card. In still another embodiment, payment vehicle 204 is a mobile payment application running on a personal telecommunications device. In yet another embodiment, payment vehicle 204 has no physical embodiment, but rather is an abstract identifier (e.g. an account number or cryptological verifier) for an associated financial account. Broadly, payment vehicle 204 identifies a financial account and provides some level of verification that user 202 is authorized to access it. Though payment vehicle 204 may take many forms, the terms “payment vehicle” and “card” are used interchangeably in this specification for brevity. In additional, there may be one or more than one payment vehicle associated with a particular funding account.

Merchant point-of-sale 206 interfaces with payment vehicle 204 on behalf of the merchant, and may take different forms depending on the form of payment vehicle 204. For example, if payment vehicle 204 is a magnetic stripe card, then merchant point-of-sale 206 may incorporate a magnetic strip reader. A single merchant point-of-sale may be able to interface with multiple forms of payment vehicle. For example, a single point-of-sale may include a magnetic stripe reader, a near-field communication (NFC) interface for contactless payments, and a smartcard reader for EMV transactions. A particular merchant may have a single point-of-sale for interfacing with all types of payment vehicle, or different forms of point-of-sale for different payment vehicles. In some embodiments, point-of-sale 206 is a software program running on a server, and is operable to receive account information over the Internet for e-commerce transactions. Point-of-sale 206 also communicates, directly or indirectly, with one or more interchanges such as interchange 208.

Interchange 208 in turn interfaces between merchant points-of-sale and financial institutions such as financial institution 210. It is the function of interchange 208 to inform merchant point-of-sale 206 whether the transaction is to be authorized. In some embodiments, this role is performed by, for example, a credit-card interchange for credit card transactions or an automated clearing house (ACH) for debit transactions. Interchange 208 receives the request, determines the issuing financial institution for payment vehicle 204, queries the issuing financial institution 210 to determine funds availability, and informs point-of-sale 206 whether financial institution 210 approves or declines the transaction.

In addition to determining whether user 202's account has sufficient funds for the transaction being processed, financial institution 210 may also perform additional validation of the transaction. For example, financial institution may compare the present transaction to user 202's account history to determine a likelihood of the transaction being fraudulent. Similarly, financial institution 210 may also validate payment vehicle 204 itself, to verify that it is in an active state. Payment vehicle 204 may be deactivated for a number of reasons: for example, if a new card is mailed to user 202, that particular card may be in a deactivated state until user 202 calls financial institution 210 to activate it. Payment vehicle 204 may also be manually deactivated if user 202 reports it lost, in order to prevent unauthorized transactions.

Payment vehicle 204 may also be temporarily deactivated by the operation of activation engine 212. In the depicted embodiment, activation engine 212 communicates with financial intuition 210. In other embodiments, however, activation engine 212 may instead communicate with interchange 208 or directly with merchant point-of-sale 206. In some embodiments, deactivation by activation engine 212 puts payment vehicle 204 in the same state as if user 202 called financial institution 210 to report a lost card. In other embodiments, it may put payment vehicle 204 into a special “temporarily deactivated” state. In some embodiments, the “temporarily deactivated” state may apply only to new transactions, while previously scheduled payments (e.g., auto-pay transactions) can proceed normally. In some embodiment, user 202 can specify that a card is deactivated only with respect to new transactions, or only with respect to previously scheduled transactions. In yet other embodiments, it may transfer the entire available balance for user 202's account to another account that is not accessible to payment vehicle 204 (for example, a savings account or interest-bearing account). In operation, activation engine 212 activates and deactivates payment vehicle 204 based on rules specified by user 202 and stored in rules data store 214.

In some embodiments, the activation or deactivation state of an account is independent of any particular transaction. This may be the case where, as discussed above, funds are transferred away from the funding account for the card to a separate account. In other embodiments, the activation or deactivation state of an account is particular to a pending transaction. For example, when an account is deactivated only with respect to card-not-present transactions, those transactions will be declined, while card-present transactions may proceed normally. In still other embodiments, these two types of activation are both used: when some transactions are possible the account is “deactivated” only at the level of individual transactions, but when no transactions are permitted, the account is locked generally (by, for example, transferring the funds to an interest bearing account as described above). In yet other embodiments, a third level of activation, at the card level rather than the account level or the transaction level is also present, so that one card linked to an account is activated while another card linked to the same account is deactivated.

Rules data store 214 stores rules specified by user 202 or otherwise determined by the system for payment vehicle 204. In some embodiments, a single rules data store stores rule data for all users, regardless of the financial institution 210 that issued payment vehicle 204. In other embodiments, each financial institution has its own rules data store or multiple rules data stores. In still other embodiments, rules data store 214 (and, in some such embodiments, activation engine 212) are stored on payment vehicle 204 itself, thereby allowing payment vehicle 204 to activate and deactivate itself based on the user-defined rules. In some embodiments, rules data store may optimize rules specified by user 202 to remove redundant activations and deactivations, or to improve lookup time needed to determine whether an account is active. For example, if a user specifies that an account is to be deactivated daily from 5 pm until 9 am, and also on weekends, then rules data store 214 may remove the redundant deactivation from 5 pm on Saturday until 9 am on Sunday. Similarly, where the user specifies more complex rules using interface 216, as discussed below, related rules may be combined or factored to reduce lookup time. In some embodiments, rules may be reordered to minimize the number of rules that must be checked to determine is a card has been deactivated. For example, if a rule deactivates a card from 5 pm until 9 am every day, that rule may be checked before more complicated, transaction-specific rules because it is easy to evaluate.

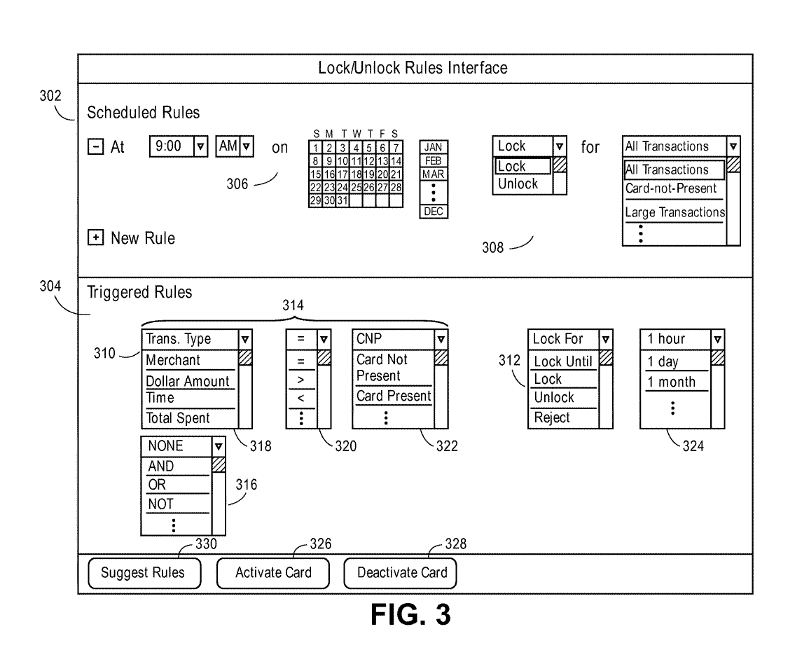

The user may populate rules data store 214 in a variety of ways. For example, interface 216, described in greater detail below with respect to FIG. 3, allows user 202 to add, edit, or delete rules for payment vehicle 204. In some embodiments, user 202 accesses interface 216 by logging onto the website of financial institution 210. In other embodiments, interface 216 is provided on an app in user 202's smartphone. In still other embodiments, interface 216 is provided to employees of financial institution 210, and user 202 can specify their desired rules to that representative by phone. In some embodiments, the user can interact with rules data store 216 without going through interface 216. For example, financial institution 216 may set up a SMS gateway that allows user 202 to manually activate or deactivate an account by sending appropriate text messages. Other ways of allowing user 202 to interact with rules data store 214 and activation engine 212 are also contemplated as being within the scope of the invention.

Turning now to FIG. 3, an exemplary user interface for configuring rules is depicted in accordance with certain embodiments of the invention. Users may configure rules for a variety of purposes. Some users may configure rules to prevent fraudulent use of their accounts. Other users may configure rules to help control their own spending or otherwise assist with money management. For example, a user who does not use a particular account for online commerce might choose to disable all card-not-present transactions. Alternatively, a user might disable an account once a certain balance has been consumed each month, in order to enforce a budget.

The embodiment depicts in FIG. 3 divides rules into scheduled rules 302 and triggered rules 304. Broadly speaking, scheduled rules are those which depend only on the passage of time rather than an external event. Thus, in the example given above, the user who wishes to disable an account from 5 pm through 9 am each day could accomplish this in one embodiment using two scheduled rules, one to disable the account each day at 5 pm and one to enable it each day at 9 am. In an alternate embodiment, a single rule indicating both the start and end for the period of time for which the account is to be disabled could instead be specified.

As shown, each of scheduled rules 302 includes a date and time 306 when the rule should activate. One of skill in the art will appreciate that there are a number of way to allow a user to input date and time, and embodiments of the invention may include any such input method. For example, date and time 306 may include two drop-down menus for time and whether the time is AM or PM, respectively, or it could allow for free-form text input of the time. In some embodiments, a user may instead be able to drag a window of time on a clock to indicate the period during which a rule should be active.

When creating rules for different purposes, users may wish to schedule activations that occur daily, weekly (or on certain days of the week), monthly (or on certain days of the month). The calendar interface shown is a convenient way to allow any of these activations to be specified by the user. A calendar page is shown, including numbers for each day of the month arranged in columns representing days of the weeks. In some embodiments, a list of months is also present next to the calendar page. The user can then specify the day or days on which the rule should activate by selecting cells on the calendar page. For example, a user could specify that rule should activate on the first of the month by selecting the corresponding cell on the calendar page. Similarly, the user could specify that the rule should activate every Monday by clicking on the appropriate column header, or every day of the week by selecting the appropriate row header. Clicking on a cell a second time will deselect that cell; thus the user could specify that a rule should activate every weekday by selecting the entire week, and then selecting the Saturday and Sunday column headers a second time to remove those days. Specific months can similarly be added to or removed from date and time 302 using the list of months provided.

Once date and time 306 have been specified, the user can specify the action for the rule. Rule actions 308 can be simple or complex. For example, an account could be completely locked, or locked for card-not-present transactions, or transactions over a given amount. Similarly, an account could be unlocked only for specified types of transactions. Where multiple cards access the same funding account, the user may be given the option to lock or unlock each card separately. Thus, for example, one card could be locked for transactions over a given amount, while another card for the same account could be unlocked for those transactions. In some embodiments, rule action 308 can additionally specify an ending time for the rule. Thus, date and time 306 could specify that the rule activates at 5 pm every day with a rule action specifying that the account is locked for 16 hours for all transactions.

In some embodiments, a user is presented with a basic interface allowing only simple actions, such as completely deactivating (locking) or activating (unlocking) an account. In other embodiments, the user may be given the option of specifying more advanced actions such as locking only a particular card for particular types of transactions. In still another embodiment, the user is presented with a basic interface having only the options to lock and unlock an account for all transactions, and has the option to activate an advanced interface with additional options. In still other embodiments, the advanced interface can be accessed by a customer-service representative of financial institution 210, and the user can configure advanced rule actions by calling financial institution 210.

In addition to scheduled rules 304, the user can also configure triggered rules 306. Triggered rules include one or more triggers such as trigger 310 that cause rule action 312 to be executed. Triggers may indicate, for example, types of activity that the user believes are indicative of fraud, or that violate a user's planned budget. Thus a user could specify that a transaction over $500 should lock the account for all card-not-present transactions (if the user is concerned about fraud) or that the same transaction should lock the account for the rest of the month (if the user is concerned about exceeding their budget). In some embodiments, triggers are made up of one or more conditions such as condition 314 joined by Boolean operators 316 such as “AND,” “OR,” or “NOT.”

Conditions may in turn be composed of a property 318, a relation 320 and a value 322. Property 318 can be any piece of information associated with the account, the transaction, or the spending vehicle. For example, properties associated with the account could include the current account balance for a credit card, the total amount spent during the present billing cycle, or the funds remaining on a prepaid card. Properties associated with the transaction could include the merchant or merchant category for the transaction, the dollar amount of the transaction, the time of the transaction, the location of the transaction, or the type of the transaction (i.e., card-present or card-not-present). Properties associated with the particular spending vehicle could include the identity or user associated with the particular spending vehicle, or the total amount charged against the particular spending vehicle this billing cycle. One of skill in the art will appreciate that many other properties are possible, and all such properties are considered to be within the scope of the invention.

For each such property 318, one or more relations are appropriate. For example, relations like “equals,” “less than,” and “greater than” are appropriate for numeric properties, while “matches” or “like” might be appropriate for free-text properties such as merchant name. In some embodiments, the values presented in the drop-down menu for the relation are automatically populated from the relations appropriate for the selected property. Similarly, appropriate values 322 can be populated. For example, if a user selects the “merchant category” property, then the “equals” relation could be populated in the relation drop-down menu, while the various merchant categories can be populated in the value drop-down. Where free text is required for a property, the drop-down menu for the value may be replaced by a free-text input field. In this manner, the user can specify one or more conditions to characterize the desired transactions.

Along with trigger 310, rule action 312 can be specified. Rule action 312 can offer similar options to rule action 308 or, as depicted, different options. For example, the user can be provided with the option to lock the account (or the individual spending vehicle) for 1 hour, 1 day, or 1 month. Other options include locking the account until the next day, the first of the month, or until the billing cycle rolls over. Alternatively, the transaction which triggered the rule can be rejected (or approved even if the account is otherwise locked). Of course, rules such as those discussed with respect to rule action 308 can also be selected. In some embodiments, the drop-down menu for specifying rule object 324 can be automatically populated in a similar fashion to the drop-down for specifying value 322.

Thus, for example, a user could create triggered rules for managing their budget specifying that if a payment is made at a bar for more than $25 after midnight, then no purchases for more than $20 can be made using the same card until the next morning, and that any card-not-present transaction made after 8 pm should be rejected. Alternatively (or in addition) the user could create rules for preventing fraud specifying that card-not-present transactions over $25 or card-present transactions made at a merchant with an out-of-state zip code should cause the account to be locked indefinitely.

Additional buttons for controlling the account, such as buttons 326 and 328 may also be present in the interface. Using these buttons, the user is able to manually activate or deactivate an account, or an individual card associated with an account. For example, if the user conducts a transaction which erroneously triggers a rule locking the account, then the user can manually unlock the account using button 326. On the other hand, if the user loses a card associated with the account, then button 328 can be used to lock the entire account, or only the particular card that was lost.

In some embodiments, an additional button 330 may be present to assist the user in creating appropriate rules. For example, the user may be presented with a transaction history for the account and given the opportunity to mark transactions which should have been blocked (e.g., those transactions which caused the user to go over their established budget). Once these transactions have been identified, rules can be generated and suggested to the user which would have prevented those transactions. In some embodiments, the user may be asked additional question to determine why the transactions should have been blocked to better generate appropriate rules. In other embodiments, the user's transaction history may be analyzed to generate a profile for the user. Rules can then be generated based on that profile so that transactions falling outside of the user's profile can cause the account to be locked. For example, if a user's profile indicates that the account is exclusively used online, then a rule may be generated specifying that card-present transactions outside the user's home state should cause the account to be locked. Unlike conventional fraud-detection heuristics, the user is given the opportunity to review, modify, and approve the rules. Thus, the process is more transparent to the user, and since the user is more familiar with their own spending habits, it can be more accurate as well.

In some embodiments, interface 216 may allow user 202 to configure multiple sets of rules that can be activated individually or in combinations. For example, the user may have a first set of rules that are applied when the user is at home, a second set of rules to be applied when the user is travelling on business, and a third set of rules to be applied when the user is on vacation. Because the user's spending patterns may be quite different in these different circumstances, allowing the user to choose one of these sets of rules to be applied can save the user having to add new rules and delete old rules every time they travel, return home, or circumstances otherwise change. In some such embodiments, such sets of rules are not mutually exclusive, but can be individually activated and deactivated. For example, the user may have a “Christmas club” rule that enforces savings for holiday expenditures. Once the user has saved up enough money, that rule can be deactivated until next year.

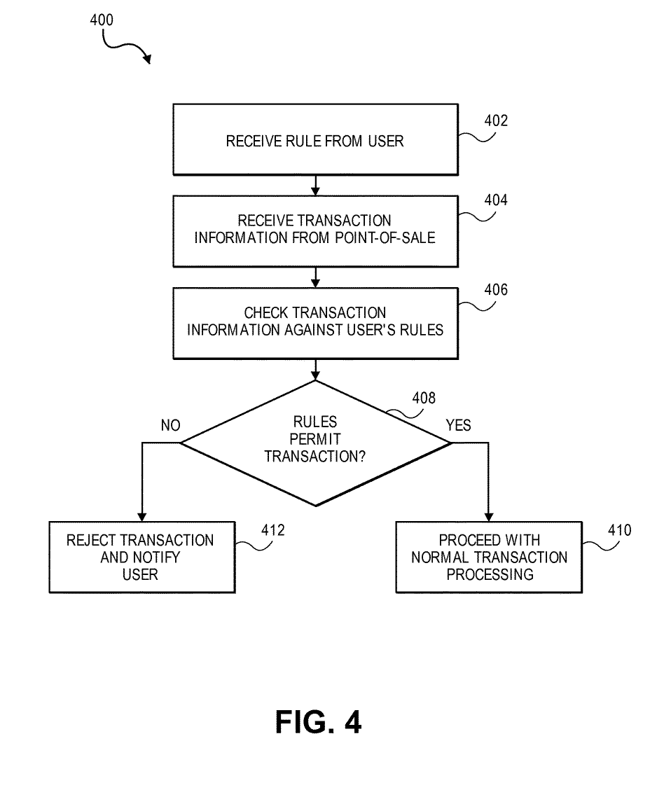

Turning now to FIG. 4, a method in accordance with embodiments of the invention is depicted, and referred to generally by reference numeral 400. Initially, at a step 402, a rule for activating and/or deactivating the account is received from the user, as described in greater detail above with respect to FIG. 3. As described therein, the rule may only disable one of a plurality of cards associated with the account, or it may disable the account entirely.

Later, at a step 404, transaction information for a card associated with the locked account is received, directly or indirectly, from a merchant point-of-sale such as merchant point-of-sale 206. The transaction may include information such as the time of the transaction, the merchant associated with the transaction, the dollar amount of the transaction, whether a card is present at the transaction, and (if so) which particular card is present.

Next, at a step 406, the transaction information received at step 404 is checked against the rule received at step 402 and other rules. As discussed in greater detail above, a rule may be applicable if it is a scheduled rule and the transaction arrived during its activation time, or if it is a triggered rule and the transaction satisfies the trigger for the rule. A rule for locking the account may do so indefinitely, for a specified period of time, or for only the present transaction, and may lock the account with respect to all transactions or only for certain types of transactions.

In some embodiments, it may be the case that multiple rules apply to a particular transaction, or that the account is activated with respect to the transaction by one rule and deactivated with respect to the transaction by another rule. Such rule conflicts may be resolved in a number of ways. In some embodiments, conflicts between time-based rules may be resolved by applying the most recently activated rule. Thus, for example, a rule that deactivated the account with respect to all transactions at 5 pm and a rule that activated the account with respect to card-present transactions at 6 pm would leave the account useable for card-present transactions after 6 pm. In other embodiments, the interface of FIG. 3 allows the user to specify a priority for the rules or an order in which they should be applied. Thus, given the above two rules, if the “deactivated with respect to all transactions” rule had a higher priority, then card-present transactions would be denied after 6 pm despite the other rule; on the other hand, if the “card-present transactions permitted after 6 pm” rule had a higher priority, then such transactions would be permitted. In still other embodiments, different classes of rules may be applied by different components of the architecture of FIG. 2, imposing a natural hierarchy for rules. For example, it may be the case that activation engine 212 deactivates a card for time-based rules by communicating the deactivation to interchange 208, while transaction-type rules are applied by financial institution 210. Thus, a transaction deactivated by a time-based rule would never be submitted to financial institution 210 to see if there is another rule that might override it.

Decision 408 determines whether the transaction received at step 404 in in compliance with the user's defined rule set, based on the results of the evaluation at step 406. If decision 408 indicates that the transaction received at step 404 complied with the users specified rules, processing proceeds to step 410, where processing of the transaction proceeds as normal. In some embodiments, the merchant point of sale is sent a transaction approval message. In other embodiments, there may be additional processing required (e.g., checking an account balance) before the transaction can be approved.

If decision 408 instead indicated that the transaction received at step 404 should be declined, processing proceeds to step 412, where a rejection of the transaction is sent to the merchant point-of-sale. In some embodiments, this is done using the same mechanism as if the customer had never called to activate the card. In other embodiments, it is done using the mechanism used if the card is reported lost or stolen. In still other embodiments, it is done using the mechanism used if insufficient credit is available to fund the transaction. In yet other embodiment, a new mechanism is used to signal that the account has been temporarily locked. In some embodiments, the user is also notified that a transaction has been rejected because the account has been locked in accordance with their rules. In some such embodiments, the user is notified via a Short Message Service (SMS) message sent to a mobile phone number associated with the account. In other such embodiments, the user is notified via a push notification sent to an app running on a smartphone that is associated with the account. In still other such embodiments, the user is notified via a telephone call. In some embodiments, this notification is accompanied by instructions for the user indicating how to unlock the account if desired. For example, if the user is notified via a telephone call, the customer service representative may offer (possibly after authenticating the user) to unlock the account so that the transaction can proceed if the user is the one making the transaction. Similarly, if the user is notified via a push notification, a link to activate user interface 216 via a smartphone app can be provided to allow the user to unlock the account, by using, for example, button 326. In some embodiments, the user may also be provided with instructions for the case where they did not authorize the transaction. For example, the phone number of the security desk of financial institution 210 may be provided.

To provide a further illustration of the operation of embodiment of the invention, an exemplary scenario is provided. The description of the operation of one embodiment of the invention below should not be construed as constraining the scope of the invention as a whole. Initially, a new customer of a financial institution opens a prepaid card account. As a part of the account creation process, a customer-service representative helps the user configure a basic set of rules. First, because the customer plans to use the account only for small business expenses, any transaction for more than $50 will be rejected based on the rules. Second, because the customer does not plan to use the account for online expenses, the account is manually locked with respect to any card-not-present transactions. Finally, because such business expenses are limited to $150 monthly, a transaction exceeding that limit will be rejected until the balance rolls over at the beginning of the next calendar month. The customer further specifies that, in such a case, the account should be locked by transferring any remaining balance to an interest-bearing account rather than by simply rejecting transactions attempted against the account. Likewise, the account is later unlocked by transferring the funds back to the prepaid card account.

After using the account for several months, a merchant at which the user has shopped is the subject of a data breach, and the user's account number is compromised. The data thief attempts to make an online purchase using the user's account. Due to the second rule configured by the user, the account is already locked for such transactions and the transaction is rejected. The user is notified via a text message that a transaction was rejected and the reason why. Also included in the text message is contact information for the security department of the financial institution. Because the user did not authorize the transaction, they contact the security department and cancel the prepaid card and request a new card for the account. Upon receiving the account, the user uses the financial institution's app on their smartphone to activate the new card. By default, the rules configured by the user for the previous card are carried over to the new card.

Several more months later, the user has an unusually large business lunch that costs more than $50. When they attempt to use their account to pay for the lunch, the transaction is rejected, based on the user's first rule. The user again receives a notification indicating that a transaction was rejected and the reason for the rejection. The user then is able to use the app on their smartphone to change the transaction limit to $75, or to manually allow the transaction. After doing this, the user resubmits the transaction, and it is approved based on the modified rule.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims. Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system for rules-based activation and deactivation of a payment vehicle associated with the user and usable by the user to initiate a transaction, comprising:
a data store storing user-defined rules for activating and deactivating the payment vehicle;
an interface allowing a user to modify the user-defined rules;
a transaction approval engine, operable to approve or reject the transaction based at least in part on the activation state of the payment vehicle; and
an activation engine, operable to change an activation state of the payment vehicle based at least in part on the user-defined rules.

2. The system of claim 1, wherein the user-defined rules include a rule for deactivating the payment vehicle based on the time of day.

3. The system of claim 1, wherein the user-defined rules include a rule for deactivating the payment vehicle based on the day of the week.

4. The system of claim 1, wherein the user-defined rules include a rule for deactivating the payment vehicle for a specified period of time.

5. The system of claim 1, wherein the user-defined rules include a rule for deactivating the payment vehicle based on a transaction made using the payment vehicle.

6. The system of claim 1, further comprising an app executable on a mobile telecommunications device that allows a user to manually activate or deactivate the payment vehicle.

7. The system of claim 6, wherein the app further allows the user to modify the user-defined rules.

8. The system of claim 1, wherein the payment vehicle is a pre-paid card.

9. The system of claim 8, wherein the activation engine deactivates the payment by transferring the balance of the pre-paid card to an account inaccessible by the pre-paid card.

10. The system of claim 1, wherein the payment vehicle can be separately activated and deactivated for card-present and card-not-present transactions.

11. The system of claim 1, wherein the data set stores a plurality of sets of user-defined rules and the interface allows the user to select a set of user-defined rules of the plurality of sets of user-defined rules to be applied by the activation engine.

12. A method of authorizing a transaction for an account associated with a user, comprising the steps of:
receiving, from the user, a rule for determining when transactions should be allowed for the account;
receiving information relating to a pending transaction for the account;
determining, based at least in part on the rule, whether the pending transaction should be allowed; and
if the transaction should not be allowed,
rejecting the transaction; and
sending, to the user, a notification that the transaction was rejected because of the rule.

13. The method of claim 12, further comprising the step of:
receiving, from the user, an additional rule for determining when transactions should be allowed for the account; and
wherein the step of determining is further based on the additional rule.

14. The method of claim 12, wherein the notification includes instructions for manually allowing the transaction.

15. The method of claim 12, wherein the rule for determining when transactions should be allowed for the account is a scheduled rule.

16. The method of claim 12, wherein the rule is specific to card-not-present transactions and wherein the pending transaction is a card-not-present transaction.

17. One or more computer-readable media storing instructions which, when executed by a processor generate a user interface for allowing a user to define rules for locking and unlocking an account, comprising:
an interface element for allowing a user to specify a time when the account should be locked or unlocked;
an interface element for allowing a user to specify a transaction that should cause the account to be locked or unlocked;
an interface element for allowing the user to lock the account; and
an interface element for allowing the user to unlock the account.

18. The computer-readable media of claim 17, wherein the interface further includes an element for automatically generating, based on a transaction history associated with the user, a rule for locking or unlocking the account.

19. The computer-readable media of claim 17, wherein the interface further includes an interface element allowing the user to specify a type of transactions for which the account should be locked.

20. The computer-readable media of claim 17, wherein the interface further includes a selector element for allowing the user to specify a set of rules of a plurality of sets of rules to be applied to unlock or unlock the account.
